(19) United States
(12) Patent Application Publication
(10) Pub. No.: US 2023/0091101 A1
(43) Pub. Date: Mar. 23, 2023

(54) HOT WATER SUPPLIER

(71) Applicant: NORITZ CORPORATION, HYOGO (JP)

(72) Inventors: Naoya Yoshida, Hyogo (JP); Toshihiko Hamagami, Hyogo (JP); Kazuhiro Nishimura, Hyogo (JP); Hisataka Hayase, Hyogo (JP)

(73) Assignee: NORITZ CORPORATION, HYOGO (JP)

(21) Appl. No.: 17/901,865

(22) Filed: Sep. 2, 2022

(30) Foreign Application Priority Data
Sep. 21, 2021 (JP) 2021-153399

(51) Int. Cl. F24H 15/104; G01N 25/00

(52) U.S. Cl. CPC F24H 15/104; G01N 25/00; F24D 17/0078

(57) ABSTRACT

A hot water supplier includes a combustion unit including multiple combustion stages; a combustion fan supplying combustion air; a fuel supply unit supplying fuel; a heat exchange unit; a water supply unit supplying hot water to heat exchange unit; a hot water tapping unit discharging hot water heated in heat exchange unit by using combustion heat obtained by burning fuel in combustion unit; and a control unit controlling heating operation. When reheating operation is allowed in which hot water from hot water tapping unit is returned to water supply unit and reheated by heat exchange unit, control unit stores heating time using only a combustion stage having minimum combustion capacity during reheating operation as time data. If this time data tends to increase over time, deterioration progress of a heat retaining material covering a hot water pipe to which hot water is supplied from hot water tapping unit is determined.

### CROSS-REFERENCE TO RELATED APPLICATION

This application claims the priority benefits of Japanese application no. 2021-153399, filed on Sep. 21, 2021. The entirety of the above-mentioned patent application is hereby incorporated by reference herein and made a part of this specification.

### BACKGROUND

### Technical Field

The disclosure relates to a combustion-type hot water supplier, and more particularly to a hot water supplier used in an instant hot water circulation system in which heated hot water is supplied as soon as a hot water supply faucet is opened.

### Related Art

Conventionally, a combustion-type hot water supplier is widely used to supply hot water heated by using combustion heat of fuel through heating operation. Since this hot water supplier starts combustion after the hot water supply faucet is opened, it takes time until the heated hot water is actually supplied, and the longer the hot water supply pipe between the hot water supplier and the hot water supply faucet, the longer the time is. Therefore, in general households, accommodation facilities, medical facilities, etc., there is a demand for an instant hot water function in which heated hot water is supplied as soon as the hot water supply faucet is.

In order to provide the instant hot water function, in some cases, hot water is constantly circulated between the hot water supplier and the hot water supply faucet, and instant hot water circulation is performed in which the hot water is reheated appropriately by the hot water supplier so as to maintain the temperature of the hot water. In an ordinary household, a single hot water supplier may handle everything from hot water supply to heating to maintain hot water temperature by adjusting the combustion capacity.

On the other hand, in lodging facilities and the like, multiple hot water supply faucets may be used simultaneously to supply large amounts of hot at one time. Therefore, by installing multiple hot water suppliers, and adjusting the number of hot water suppliers that perform heating operations according to the amount of hot water supplied and the combustion capacity of each hot water supplier, it is possible to handle from supplying a large amount of hot water to heating to maintain the hot water temperature.

The hot water pipe that circulates hot water is usually covered with a heat retaining material formed of, for example, foamed resin in order to prevent the hot water temperature from dropping due to the influence of outside air temperature and the wind. However, long-term use may cause deterioration of the heat retaining material, resulting in a decrease in heat insulating performance.

A drop in the temperature of hot water when the hot water is circulated in the hot water pipe increases due to decrease in heat retention performance, therefore the heating time (heating frequency) for maintaining the temperature of the circulating hot water increases, fuel consumption increases, and heating costs increase. Further, since the deterioration of the heat retaining material is not noticeable and the deterioration of the heat insulating performance is often not noticed, the fuel consumption may increase and the heating cost may continue to increase, which is not preferable.

As a technology to detect deterioration of heat retention performance, as in Patent Literature 1, for example, to prevent freezing of the circulation passage between a hot water heater and the hot water supplier, there is known a technique for determining the peeling of a heat retaining material in a circulation passage based on the temperature of hot water before the circulation pump is driven and the minimum temperature of hot water when the circulation pump is driven. Further, as in Patent Literature 2, in a hot water supplier that mixes hot water from a hot water storage tank including the thermal insulating material for heat retaining with tap water and discharges hot water, there is known a technique for detecting, when the amount of tap water supply relative to daily output of hot water is less than the past record, performance degradation of the thermal insulating material, assuming that the temperature of the hot water in the hot water storage tank is also lower than in the past.

### CITATION LIST

### Patent Literature

[Patent Literature 1] Japanese Patent No. 3149012
[Patent Literature 2] Japanese Patent No. 4287852

### Problems to be Solved

In Patent Literature 1, peeling of the heat retaining material in the circulation passage is detected based on fluctuation of the hot water temperature during circulation for anti-freezing using the fact that the heat dissipation property differs depending on the position in the circulation passage, so it is not easy to be applied to a configuration in which the hot water heated is constantly circulated for an instant hot water function. Further, in Patent Literature 2, since the performance degradation of the thermal insulating material is detected based on the relationship between the amount of hot water tapped from a hot water storage tank with a certain amount of heat and the amount of water supplied, it is difficult to be applied to a configuration that reheats hot water for an instant hot water function. Therefore, there is a need for a technique to determine the deterioration of a heat retaining material applicable to the circulation passage for an instant hot water function.

An object of the disclosure is to provide a hot water supplier capable of determining, when it is configured to allow the hot water that has been heated and discharged to be returned and reheated for an instant hot water function, the progress of deterioration of a heat retaining material covering the hot water pipe through which the discharged hot water passes.

### SUMMARY

### Means for Solving the Problems

The hot water supplier according to technical solution 1 of the disclosure is a hot water supplier including a combustion unit that includes a plurality of combustion stages for switching between combustion capacities according to required heat; a combustion fan that supplies combustion air to the combustion unit; a fuel supply unit that supplies fuel to the combustion unit; a heat exchange unit; a water supply unit that supplies hot water to the heat exchange unit; a hot water tapping unit that discharges hot water heated in the heat exchange unit by using combustion heat obtained by burning fuel in the combustion unit through heating operation; and a control unit that controls the heating operation. When it is configured that reheating operation is allowed in which the hot water from the hot water tapping unit is returned to the water supply unit and heated by the heat exchange unit, the control unit stores heating time using only a combustion stage having a minimum combustion capacity of the combustion unit during the reheating operation as time data. If this time data tends to increase over time, progress of deterioration of a heat retaining material that covers a hot water pipe to which the hot water is supplied from the hot water tapping unit is determined.

The hot water supplier according to the disclosure of technical solution 2 is based on the disclosure of technical solution 1, in which the control unit is communicably connected to an external server via a communication network and transmits the time data to the external server, and the progress of deterioration of the heat retaining material is determined by the external server instead of the control unit based on the accumulated time data.

The hot water supplier according to the disclosure of technical solution 3 is based on the disclosure of technical solution 1, in which the control unit corrects the time data according to outside air temperature.

### BRIEF DESCRIPTION OF THE DRAWINGS

FIG. 1 is an explanatory diagram of an instant hot water circulation system provided with a hot water supplier according to an embodiment of the disclosure.

FIG. 2 is a diagram showing a configuration of a hot water supplier according to an embodiment of the disclosure.

FIG. 3 is a correspondence table of combustion capacity and combustion stage used.

FIG. 4 is a diagram showing an example of time data.

FIG. 5 is a diagram showing another example of time data.

FIG. 6 is a diagram illustrating the relationship between monthly average temperature and one-stage combustion time.

FIG. 7 is a diagram showing an instant hot water circulation system provided with a plurality of hot water suppliers.

### DESCRIPTION OF THE EMBODIMENTS

Hereinafter, embodiments for implementing the disclosure will be described based on embodiments.

### Embodiment

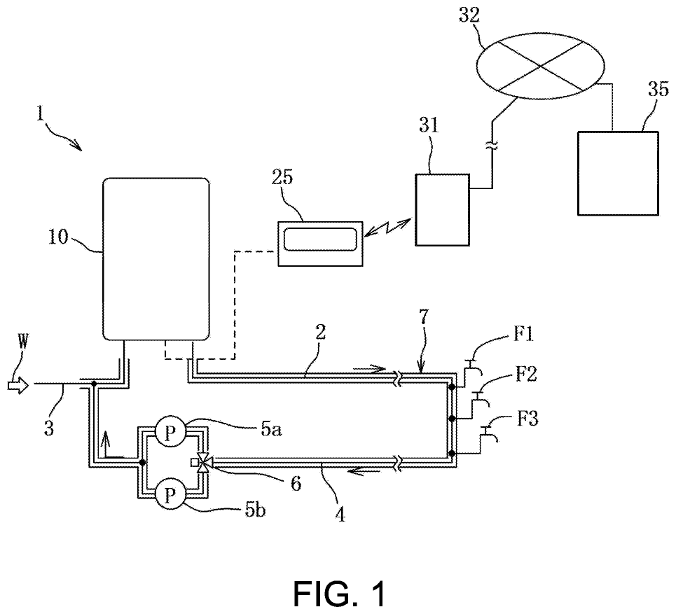

First, an instant hot water circulation system 1 that provides instant hot water function will be described. As shown in FIG. 1, a combustion-type hot water supplier 10 is connected to a hot water supply pipe 2 equipped with a plurality of hot water supply faucets F1-F3 used in, for example, a kitchen or a bathroom of a general household. A water supply pipe 3 is connected to the hot water supplier 10, and as shown by an arrow W, tap water supplied from the water supply pipe 3 is heated through the heating operation of the hot water supplier 10 and supplied to the plurality of hot water supply faucets F1-F3 via the hot water supply pipe 2.

For an instant hot water function that heated hot water is supplied as soon as the hot water supply faucets F1-F3 are opened, the instant hot water circulation system 1 is configured such that the hot water heated by the hot water supplier 10 and supplied to the hot water supply pipe 2 returns from the hot water supply pipe 2 to the hot water supplier 10 via a return pipe 4 connected to the water supply pipe 3. Circulation pumps 5a and 5b are respectively installed in the branch pipes of the return pipe 4 which are branched into two in the middle, and the branch pipes merge and are connected to the water supply pipe 3. A branch point of the return pipe 4 is equipped with a flow path switching valve 6 for switching between the circulation pumps 5a and 5b for circulating hot water. In order to constantly circulate hot water, one of the circulation pumps 5a and 5b is always driven, and the circulation pump to be driven is switched periodically.

The hot water supply pipe 2 and the return pipe 4 are hot water pipes to which hot water is supplied from the hot water supplier 10, and are covered with a heat retaining material 7 in order to prevent heat dissipation of the circulating hot water. The heat retaining material 7 is formed of, for example, a foamed resin. When the temperature of the circulating hot water becomes lower than the preset reheating start temperature, the temperature of the circulating hot water is maintained by performing a reheating operation of reheating through the heating operation of the hot water supplier 10 while circulating the hot water.

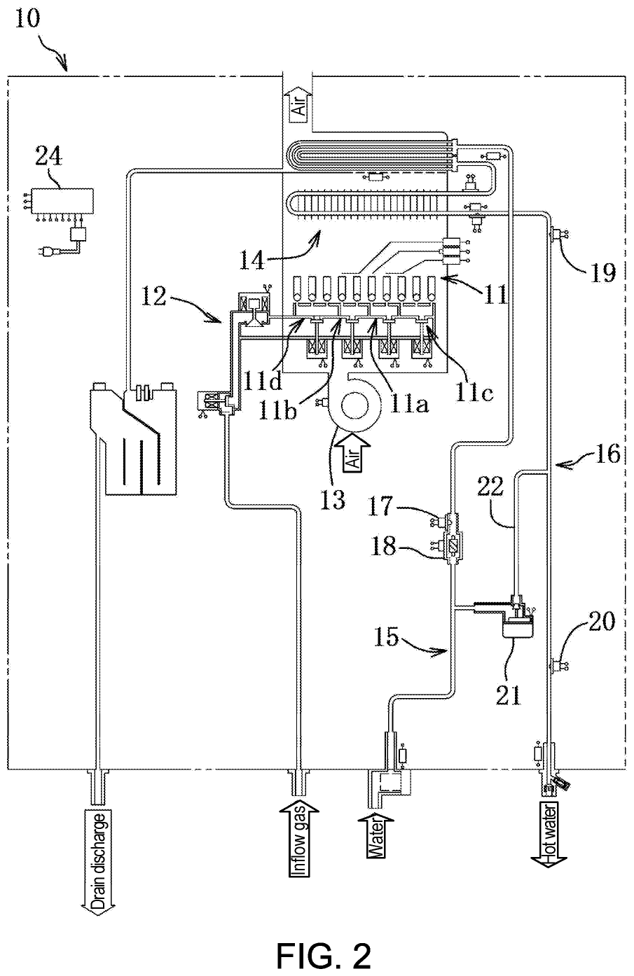

Next, the hot water supplier 10 will be described. As shown in FIG. 2, the hot water supplier 10 includes a combustion unit 11; a fuel supply unit 12 that supplies fuel to the combustion unit 11; a combustion fan 13 that supplies combustion air to the combustion unit 11; and a heat exchange unit 14 that heats hot water using the combustion heat of the combustion unit 11. The combustion unit 11 has a plurality of combustion stages 11a-11d so as to switch between the combustion capacities according to the heat required for the hot water to be discharged at a set temperature. Usually, of the plurality of combustion stages 11a-11d, the combustion stage 11a that is first ignited is the combustion stage having the minimum combustion capacity.

The water supply pipe 3 is connected to a water supply unit 15 that supplies hot water to the heat exchange unit 14. A hot water tapping unit 16 for discharging the hot water heated by the heat exchange unit 14 is connected to the hot water supply pipe 2. The water supply unit 15 includes a water supply temperature sensor 17 and a flow rate sensor 18. The hot water tapping unit 16 includes a first hot water tapping temperature sensor 19 and a second hot water tapping temperature sensor 20, and by mixing the hot water heated by the heat exchange unit 14 with the hot water from the water supply unit 15 via a bypass passage 22 provided with a flow rate regulating valve 21, the temperature is adjusted and the hot water is discharged.

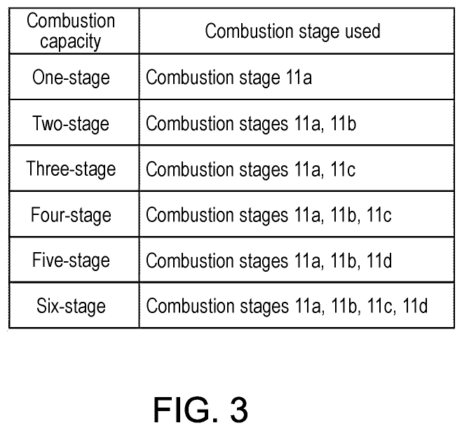

The hot water supplier 10 includes a control unit 24 that drives the combustion fan 13, drives the flow rate regulating valve 21, and adjusts the combustion capacity of the combustion unit 11 to control the heating operation. As shown in FIG. 3, the combustion capacity of the combustion unit 11 may be adjusted by combining the combustion stages used among the plurality of combustion stages 11a-11d, or the amount of fuel supplied by the fuel supply unit 12 may also be adjusted. For example, when the minimum combustion capacity is one stage, only the combustion stage 11a is used, and combustion using only the combustion stage 11a having the minimum combustion capacity is referred to as one-stage combustion.

The control unit 24 receives detection signals of the water supply temperature sensor 17, the flow rate sensor 18, the first hot water tapping temperature sensor 19, and the second hot water tapping temperature sensor 20, and adjusts the temperature of the hot water heated by the heat exchange unit 14 to the set temperature. The control unit 24 is connected to a hot water supply remote controller 25 capable of setting the hot water supply temperature and the like, and is communicably connected to an external server 35 connected to a communication network 32 such as the Internet through a communication device 31 connected to the hot water supply remote controller 25.

When the hot water supply faucet F1 of the plurality of hot water supply faucets F1-F3, for example, is opened to start the supply of hot water, the water supply temperature sensor 17 detects the inflow of low-temperature tap water or the flow rate sensor 18 detects a flow rate larger than that during circulation, and the heating operation is started. When hot water is not supplied, in a case where the circulating hot water gradually dissipates heat and the detected temperature of the water supply temperature sensor 17 drops below the reheating start temperature, for example, reheating operation is performed by burning using only the combustion stage 11a having the minimum combustion capacity (one-stage combustion). Moreover, in a case where the detected temperature of the water supply temperature sensor 17 becomes equal to or higher than a preset heating end temperature, the reheating operation is ended. Through the reheating operation, the temperature of the circulating hot water is maintained, for example, within a certain range near the hot water supply temperature set by the hot water supply remote controller 25.

During the heating operation including the reheating operation, the control unit 24 takes the time data for heating using only the combustion stage 11a having the minimum combustion capacity (one-stage combustion time) as time data, and stores and accumulates heating operation data including the time data. Further, when the one-stage combustion time (time data) tends to increase over time, it is determined that the heat retaining material 7 covering hot water pipes (hot water supply pipe 2, and return pipe 4) to which heated hot water is supplied is deteriorating. One-stage combustion is sufficient to maintain the temperature of the circulating hot water, and the heating operations of the one-stage combustion is mostly a reheating operation for maintaining the temperature of the circulating hot water.

The increase in the one-stage combustion time (time data) indicates that the temperature of the discharged hot water drops immediately during circulation and the frequency of the reheating operation increases. Therefore, the control unit 24 may determine the progress of deterioration of the heat retaining material 7 by the increase in the one-stage combustion time. As a result of the determination, when the heat retaining material 7 needs to be replaced and repaired, a notification prompting the replacement and repair may be performed, for example, by displaying on the hot water supply remote controller 25 of the hot water supplier 10.

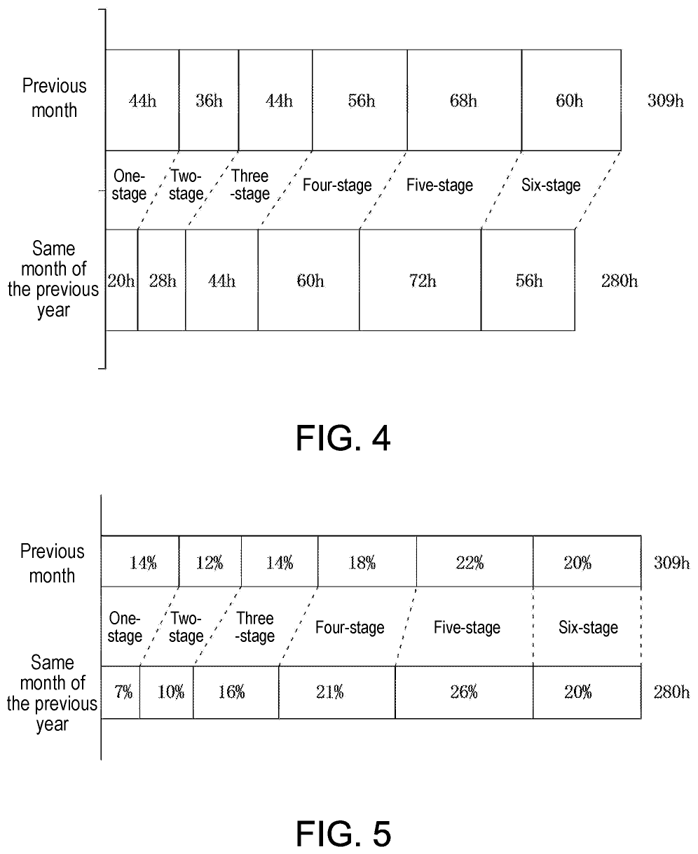

For example, as shown in FIG. 4, by comparing the total one-stage combustion time of the previous month with the total one-stage combustion time of the same month of the previous year, it may be determined that the heat retaining material 7 has deteriorated if there is an increase of a % compared to the previous year. The value of a, which is a reference for determining the deterioration of the heat retaining material 7, may be appropriately set based on an experiment or the like, or may be compared with the time data of the first year when the hot water supplier 10 is installed.

Also, for example, as shown in FIG. 5, by comparing the ratio of the one-stage combustion time to the cumulative heating time of the heating operation previous month and the ratio of the one-stage combustion time to the cumulative heating time of the heating operation in the same month of the previous year, it may also be determined that the heat retaining material 7 has deteriorated if there is an increase of by β% compared to the previous year. The value of β, which is a reference for determining the deterioration of the heat retaining material 7, may be appropriately set based on an experiment or the like.

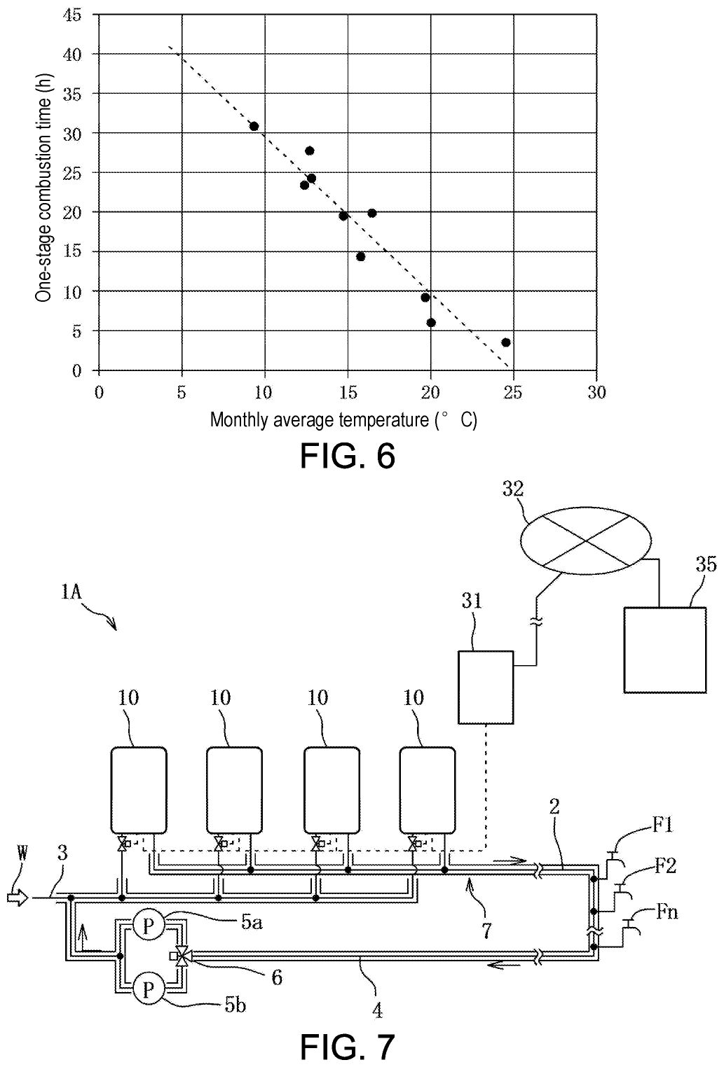

The lower the outside air temperature, the easier it is for the temperature of the circulating hot water to drop. For example, as shown in FIG. 6, as the monthly average temperature is lower, the frequency of reheating operation increases and the cumulative total of one-stage combustion time increases. In this example, when the monthly average temperature drops by 1° C., the cumulative total of the one-stage combustion time tends to increase by about 2 hours, such that the time data may be corrected based on the outside air temperature.

For example, correction is performed by averaging the time data of the period when the outside air temperature is high and the one-stage combustion time is short and of the period when the outside air temperature is low and the one-stage combustion time is long so as not to depend on the outside air temperature. The outside air temperature may be obtained from a weather server (not shown) that provides weather data via the communication network 32, for example, and when the hot water supplier 10 is provided with an outside air temperature sensor (not shown), the detected temperature by the outside air temperature sensor may be used as the outside air temperature. By correcting the time data, the progress of deterioration of the heat retaining material 7 can be determined not only by comparison with the same month of the previous year but also by comparison between arbitrary months. Further, the relationship shown in FIG. 6 is different for each instant hot water circulation system, it is necessary to accumulate combustion operation data including time data for each instant hot water circulation system in order to correct the time data.

It is also possible that the control unit 24 periodically transmits the heating operation data including the one-stage combustion time (time data) newly stored during the heating operation to the external server 35, and instead of the control unit 24, the external server 35 determines that the deterioration of the heat retaining material 7 is progressing when the accumulated time data tends to increase over time. There is no need to accumulate long-term heating operation data in the control unit 24, and progress of deterioration of the heat retaining material 7 can be determined without increasing the processing load of the control unit 24. Therefore, the control unit 24 having a high capacity is not required, and the increase in the manufacturing cost of the hot water supplier 10 is suppressed.

As shown in FIG. 7, for example, in accommodation facilities that are large to some extent, in order to be able to handle a large amount of hot water supply from the plurality of hot water supply faucets F1-Fn, a plurality of hot water suppliers 10 are installed in parallel between the water supply pipe 3 and the hot water supply pipe 2 to constitute an instant hot water circulation system 1A. When there is no use of hot water supply, the reheating operation for maintaining the temperature of the circulating hot water may often be sufficiently heated by performing one-stage combustion with any one of the plurality of hot water suppliers 10. Therefore, even when the instant hot water function is provided by the plurality of hot water suppliers 10, the progress of deterioration of the heat retaining material 7 can be determined in the same manner as in the case of one hot water supplier 10.

The operation and effect of the hot water supplier 10 according to the above embodiments will be described. The hot water supplier 10 discharges hot water heated by the heating operation from the hot water tapping unit 16. In the case when it is configured to allow the hot water discharged to be returned to the water supply unit 15 and reheated for an instant hot water function in which the heated hot water is supplied as soon as the hot water supply faucets F1-F3 are opened, the hot water pipes (hot water supply pipe 2, return pipe 4) through which the discharged hot water passes are covered with the heat retaining material 7 for preventing heat dissipation. As a result, in the reheating operation of reheating the circulating hot water, the temperature of hot water may be maintained by circulating hot water while heating by burning using only the combustion stage 11a of the combustion unit 11 having the minimum combustion capacity (one-stage combustion). Moreover, the increase in the heating time (time data) using only the combustion stage 11a having the minimum combustion capacity indicates that the temperature of the discharged hot water drops immediately during circulation and the frequency of reheating increases, therefore the control unit 24 may determine the progress of deterioration of the heat retaining material 7 based on the increasing tendency of the time data.

The control unit 24 transmits the heating time (time data) using only the combustion stage 11a having the minimum combustion capacity to the external server 35. Further, instead of the control unit 24, the external server 35 determines the progress of deterioration of the heat retaining material 7 based on the accumulated time data. The progress of deterioration of the heat retaining material 7 can be determined without increasing the processing load of the control unit 24, therefore the control unit 24 having high processing capability is not required, and the increase in manufacturing cost of the hot water supplier 10 can be suppressed.

Moreover, by correcting the time data according to the outside air temperature by the control unit 24, the time data of the period when the outside air temperature is high and the heating time using only the combustion stage 11a having the minimum combustion capacity is short and of the period when the outside temperature is low and the heating time using only the combustion stage 11a having the minimum combustion capacity is long may be averaged according to the outside temperature, such that the progress of deterioration of the heat retaining material 7 can be easily determined.

In addition, a person skilled in the art may implement the embodiments with various modifications without deviating from the gist of the disclosure, and the disclosure includes such modifications.

According to the above configuration, the hot water supplier discharges hot water heated through the heating operation from the hot water tapping unit. When it is configured to allow the hot water that has been discharged to be returned to a water supply unit and reheated for an instant hot water function in which the heated hot water is supplied as soon as a hot water supply faucet is opened, the passage of the hot water discharged is covered with a heat retaining material for preventing heat dissipation. As a result, heat dissipation is suppressed, and in the reheating operation that reheats the circulating hot water, the temperature of the hot water may be maintained by circulating the hot water while heating by burning using only the combustion stage having the minimum combustion capacity of the combustion unit. Moreover, the increase in the heating time using only the combustion stage having the minimum combustion capacity indicates that the temperature of the discharged hot water drops immediately during circulation and the frequency of reheating increases, therefore the control unit may determine the progress of deterioration of the heat retaining material based on the increasing tendency of the heating time using only the combustion stage having the minimum combustion capacity.

According to the above configuration, the control unit transmits the time data to the external server. Instead of the control unit, the external server determines the progress of deterioration of the heat retaining material based on the accumulated time data. Therefore, the progress of deterioration of the heat retaining material can be determined without increasing the processing load of the control unit, and since a control unit having a high processing capacity is not required, an increase in the manufacturing cost of the hot water supplier can be suppressed.

According to the above configuration, by correcting the time data according to the outside air temperature, the time data of the period when the outside air temperature is high and the heating time using only the combustion stage having the minimum combustion capacity is short and of the period when the outside temperature is low and the heating time using only the combustion stage having the minimum combustion capacity is long may be averaged according to the outside temperature, such that the progress of deterioration of the heat retaining material can be easily determined.

### Effects

According to the hot water supplier of the disclosure, when it is configured to allow the hot water that has been heated and discharged to be returned and reheated for an instant hot water function, it is possible to determine the progress of deterioration of a heat retaining material that covers the hot water pipe through which discharged hot water passes.

What is claimed is:

1. A hot water supplier, comprising a combustion unit that comprises a plurality of combustion stages for switching between combustion capacities according to required heat; a combustion fan that supplies combustion air to the combustion unit; a fuel supply unit that supplies fuel to the combustion unit; a heat exchange unit; a water supply unit that supplies hot water to the heat exchange unit; a hot water tapping unit that discharges hot water heated in the heat exchange unit by using combustion heat obtained by burning fuel in the combustion unit through heating operation; and a control unit that controls the heating operation,
wherein, when the hot water supplier is configured to allow reheating operation in which the hot water from the hot water tapping unit is returned to the water supply unit and heated by the heat exchange unit, the control unit stores heating time using only a combustion stage having a minimum combustion capacity of the combustion unit during the reheating operation as time data, and if this time data tends to increase over time, progress of deterioration of a heat retaining material that covers a hot water pipe to which the hot water is supplied from the hot water tapping unit is determined.

2. The hot water supplier according to claim 1, wherein the control unit is communicably connected to an external server via a communication network and transmits the time data to the external server, and the progress of deterioration of the heat retaining material is determined by the external server instead of the control unit based on the accumulated time data.

3. The hot water supplier according to claim 1, wherein the control unit corrects the time data according to outside air temperature.
